(19) United States
(12) Patent Application Publication
(10) Pub. No.: US 2004/0039780 A1
(43) Pub. Date: Feb. 26, 2004

(54) Method of realizing multiple simultaneous chat sessions through message transfer

(76) Inventors: Dai-Shui Ho, Taipei Hsien (TW); Shih-Kuang Tsai, Taipei Hsien (TW); Zhi-Yun Zhang, Shanghai (CN)

Correspondence Address: NAIPO (NORTH AMERICA INTERNATIONAL PATENT OFFICE), P.O. BOX 506, MERRIFIELD, VA, 22116, US

(21) Appl. No.: 10/064,877

(22) Filed: Aug. 26, 2002

(51) Int. Cl. G06F 15/16

(52) U.S. Cl. 709/205; 455/466; 709/206

(57) ABSTRACT

A method of chatting for handheld devices and a related system. A user sets up caller and receiver information, allowing the handheld device to determine whether or not incoming messages are from the set receivers. The handheld device displays all messages from the set receivers. The system has a message chat settings module, a message transfer module, a message entry module, and a message filtering module. The user enters a message chat program, sets up information for the chat parties, and uses message transfer to perform multi-party chat.

### BACKGROUND OF INVENTION

1. Field of the Invention

The present invention relates to chat methods, and more particularly, the present invention provides a method of using a network to perform message transfer between multiple users, for use in a handheld device.

2. Description of the Prior Art

With an arrival of a knowledge and information age, to support a diversification of network communication applications, and with a rapid progress in hardware and software transmission technology, handheld digital device popularity has already become a general market trend. All kinds of developments in new, advanced handheld devices have caused a past emphasis on external look and feel to evolve gradually into a demand for the latest features. Aside from a particular emphasis on personal information management (PIM) capabilities, now there is also a demand for message transfer functions.

According to many recent surveys of handheld digital apparatus users, the most well-received and frequently used tool is messaging. A most important reason, aside from price consideration, is that messaging provides users a way to use a few words to communicate with another party without making a call, which is convenient and saves money. Though up to now, original “message transfer” functions that only provided one-on-one message transfer over a service network of a special system supplier already allow message transfer across different networks, and some service suppliers even go one step further and provide users with a special ability to send a message to multiple recipients simultaneously, there is an underlying premise that each user must be using a common supplier if they wish to communicate with multiple parties simultaneously. This kind of limitation causes users who want to use the service to lose their freedom to choose a provider. Aside from being confined to choosing one particular provider, the user cannot even perform multi-party message transfer with users from other system providers to enjoy chat interaction.

### SUMMARY OF INVENTION

Thus, it is an objective of the claimed invention to provide a multi-party message transfer chat method that allows each party to change information settings, performs automatic recognition of a source of incoming information, and displays the incoming information in a special background.

A method of the claimed invention includes turning on a handheld device and entering a message chat program, setting chat information for message transfer, and performing multi-party simultaneous real-time chat through message transfer.

A system of the claimed invention at least has a message chat settings model, a message transfer module, a message content input display module, and a message content filter module.

It is an advantage of the claimed invention that it provides users with a robust chat program that can be used in handheld devices.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is an architecture diagram of a handheld device multi-party chat system according to the present invention.

FIG. 2a is a flow chart of operation of a multi-party chat method according to the present invention.

FIG. 2b is a flow chart of setup procedures (step A of FIG. 2a) of the method according to the present invention.

FIG. 2c is a flow chart of performing message transfer (step B of FIG. 2a) in the method according to the present invention.

FIG. 3 is a diagram of a user interface of the method according to the present invention.

### DETAILED DESCRIPTION

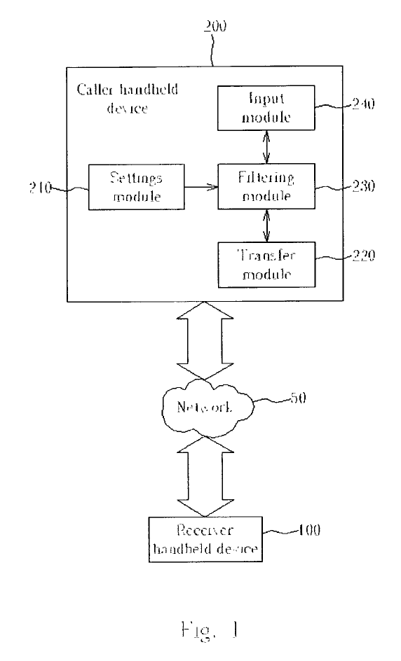

The present invention is a method of realizing multi-party simultaneous chat interaction through message transfer. Please refer to FIG. 1. Taking a network 50 as a message transfer medium, after a caller performs information settings for chatting parties in a handheld device 200, under a condition not limited by user system environment, message transfer is performed between the caller and a called user using a handheld device 100, achieving multi-party simultaneous chat interaction.

As shown in FIG. 1, the present invention method employs many interconnected modules, each with different functionality. The handheld device 200 comprises a message chat settings module 210, a message transfer module 220, a message content filter module 230, and a message content input display module 240. The message chat settings module 210 is used for setting chat caller and receiver information. When the caller turns on the handheld device 200 and enters the chat program, the caller can use the settings module 210 to set a nickname and enter a phone number of the receiver. The message transfer module 220 is used for receiving all message content sent through the network 50, and responsible for sending all message content sent by the caller. The message content filtering module 230 is used for individually filtering transferred and received message content according to the specific users set up in the message chat settings module 210, and immediately sending the message content of the specific users in the settings to the message content input display module 240 for display. Additionally, as for incoming content that does not come from the specific users in the settings, the filtering module 230 treats the message content as a general message (such as SMS), and sends the message on to a normal message processing module of the handheld device 200 of the caller. The message content input display module 240 is used for immediately displaying the message content transmitted by the users in the settings of the message chat settings module 210 on the handheld device 200, and further provides for the user to input message content. The message content is filtered by the message content filtering module 230, and then sent out by the message transfer module 220.

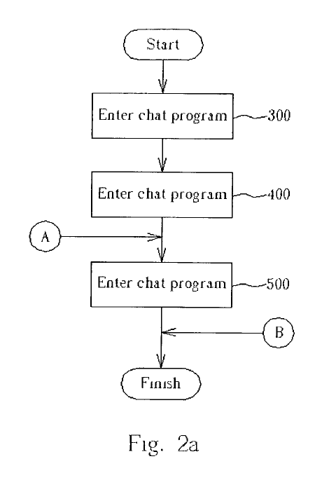

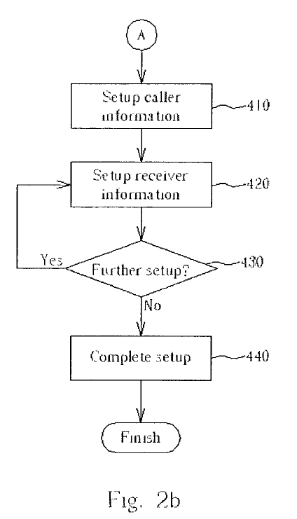

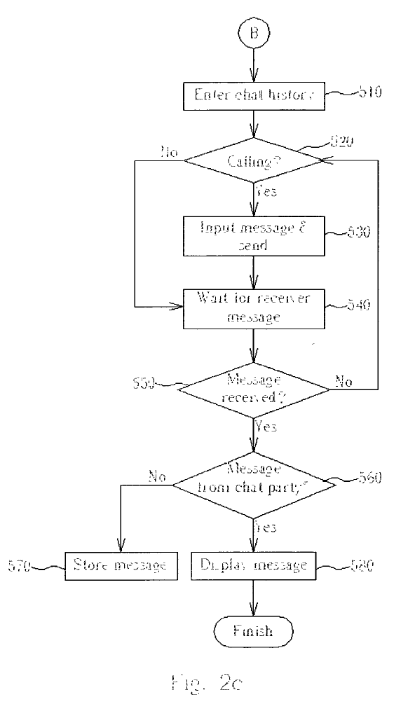

Please refer to FIG. 2a, which is a flow chart of operation of the multi-party chat method according to the present invention. Each step is described below:Step 300: First, the user turns on the handheld device, and enters the message chat program.

Step 400: The user sets information for the users of the message transfer chat. A major objective here is to allow the handheld device, upon sending and receiving messages, to be able to determine whether the message to be sent or received is a general message, or is a message going to, or coming from, a set user. Step A describes this step in further detail in FIG. 2b.

Step 500: The user can perform immediate multi-party chat through use of message transfer. Step B describes this process more thoroughly, and is shown in FIG. 2c.

Please refer to FIG. 2b, which is a flow chart of Step A mentioned above. Particularly, Step A covers more thoroughly setting up the handheld device 200 for chat, and comprises the following steps:Step 410: When the user enters the chat interface, the caller information is set up. In this step, a nickname is chosen for chatting with multiple parties, along with setting up message text color.

Step 420: Information of the receivers is set up. Phone numbers of the receivers are entered, and can belong to any system supplier. In addition, colors of text used to display incoming messages from the receivers can be chosen, which allows the user to quickly distinguish between different chatters in the chat interaction. In addition, the user can also select a specific group of receivers with which to perform private chat that is not visible to chatters outside of the clique.

Step 430: After setting up each individual receiver, the system automatically asks the caller whether or not to continue information setup. If yes, return to step 420 and setup is continued.

Step 440: If the user has already completed setup, and sent an acknowledgement message, the user has fully completed setup of the message transfer chat information.

At this point, the user can use the handheld device 200 to perform chat interaction with the multiple users that have been set up.

Please refer to FIG. 2c for a description of part B of FIG. 2a. Transmission and reception of messages in the present invention method comprises the following:Step 510: The user enters the message chat interface of the handheld device. At this point, the method has already begun operation;Step 520: If the user wishes to send a message, go to step 530;Step 530: The user uses an input method (such as keyboard input, touchpad input, or speech recognition) to enter content of a message. Upon completion of the input, the message can be sent out at any time;Step 540: If the user is not inputting a message, then the system continues to wait for any of the receivers to send a message; Step 550: An incoming message is received by the system; Step 560: The system determines whether or not the message was sent by one of the set receivers. If not, go to step 570. If so, go to step 580;Step 570: Because the message is a normal incoming message, the system sends the message to a module that normally handles incoming messages, for the user to deal with later; Step 580: The incoming message is a message from the set receivers, so the system displays the message on the interface according to the previously set style.

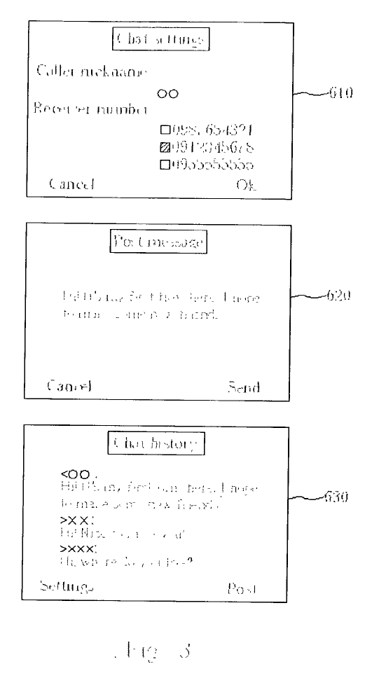

Please refer to FIG. 3, which is a diagram of the user interface of the present invention when performing the present invention method. This figure primarily shows how the present invention method uses a very common Short Message System (SMS), in a cellular phone, to practically implement the multi-party simultaneous chat interaction. When the user enters a settings interface 610, the user can set caller information and receiver information, including a caller nickname, receiver phone numbers, and which receivers to include. After completion, the user can then enter a chat interface 620 and begin sending messages. After the user has finished entering and sending the message, the user can enter the chat history interface 630 and view all messages that have been received in the chat process. As shown in the history interface 630, the messages sent by the user are also displayed in the history interface 630. In addition, the messages that come from the receivers set up in the settings interface 610 also appear in the history interface 630. In this manner, the caller and the receivers can see the entire messaging history of the chat session on their respective cellular phones.

Please note that in the settings interface 610, the user with nickname “00” has entered three different phone numbers (1-234-5678,1-555-1212,1-876-5432), and that a selection box next to, and corresponding to, the second phone number (1-555-1212) is black. This indicates that when the user is chatting, messages from the user will only be sent to the receiver that has been selected, and will not be visible to other receivers. However, the messages from all of the receivers are displayed. In this way, the user can choose to send a private message to any specific party in the chat through a quick change of settings.

The method of the present invention for performing multi-party chat in handheld devices allows the user to transfer messages among many parties within a graphical interface, without being restricted by system supplier limitations.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A system for realizing multi-party chat through message reception and transmission in a handheld device over a network, the system comprising:
a message chat settings module for setting up information of a caller and a receiver;
a message transmission/reception module for transmitting and receiving messages;
a message entry display module for displaying messages and inputting messages; and
a message filtering module for determining whether a message corresponds to the receiver.

2. The system of claim 1 wherein the handheld device is capable of receiving and transmitting signals.

3. The system of claim 2 wherein the handheld device is a personal digital assistant, a mobile phone, or a smart phone.

4. The system of claim 1 wherein the network is a wired network or a wireless network, and the messages are sent and received through a communications protocol.

5. The system of claim 4 wherein the communications protocol is a wireless application protocol, a general packet radio services, a code-division multiple access, or a hypertext transfer protocol.

6. The system of claim 1 wherein message input is accomplished through a keyboard, a digital touchpad, or a speech recognition system.

7. A method of realizing multi-party chat through message transmission and reception over a network, for use in a handheld device, the method comprising:
entering a message chat program;
setting up information of a caller and a receiver; and
transferring messages between the caller and the receiver.

8. The method of claim 7 wherein the network is a wired network or a wireless network, and the messages are transferred through a communications protocol.

9. The method of claim 8 wherein the communications protocol is a wireless application protocol, a general packet radio service, a code-division multiple access, or a hypertext transfer protocol.

10. The method of claim 7 wherein the handheld device is capable of transmitting and receiving messages.

11. The method of claim 10 wherein the handheld device is a personal digital assistant, a mobile phone, or a smart phone.

12. The method of claim 7 wherein setting up the caller and receiver information comprises:
setting up a caller information;
setting up a receiver information; and
completing setup of the caller and receiver information.

13. The method of claim 12 wherein the caller information comprises a nickname and a text color.

14. The method of claim 12 wherein the receiver information comprises a phone number, a text color, and an appointed receiver field.

15. The method of claim 14 wherein selecting the appointed receiver field provides chat with the receiver.

16. The method of claim 7 further comprising:
entering a message chat history display;
calling the receiver;
completing a message through an input method and sending the message;
waiting for the receiver to send a message and initiate chat;
sending a message to the receiver;
storing the message in the handheld device; and
displaying the message on the chat history display.

17. The method of claim 16 wherein the input method is a keyboard, a touchpad, or a speech recognition system.

18. A system for realizing multi-party chat through message transfer over a short message system of a mobile phone through a wireless mobile network, the system comprising:
a message chat settings module for setting information of a caller and a receiver;
a message transmission/reception module for sending and receiving messages;
a message entry display module for displaying messages and inputting messages;
a message chat history information bank for storing and retrieving a chat message history; and
a message filtering module for determining whether a message corresponds to the receiver.

19. The system of claim 18 wherein inputting messages is accomplished through a keyboard, a touchpad, or a speech recognition system.

20. The system of claim 18 wherein the message chat history information bank stores at least one chat message.

21. The system of claim 20 wherein the chat message comprises a nickname, a phone number, a timestamp, and a text content field.

22. A method of realizing multi-party chat through message transfer over a short message system of a mobile phone through a wireless mobile network, the method comprising:
entering a chat program;
setting up information of chat parties; and
transferring messages between the chat parties.

23. The method of claim 22 further comprising:
setting up a caller information;
setting up a receiver information;
completing setup of the information of the message chat parties.

24. The method of claim 23 wherein the caller information comprises a nickname and a text color.

25. The method of claim 23 wherein the receiver information comprises a phone number, a text color, and an assigned receiver field.

26. The method of claim 25 wherein selecting the assigned receiver field allows chat with the receiver.

27. The method of claim 22 further comprising:
entering a message chat history display;
calling the receiver;
completing a message through an input method and sending the message;
waiting for the receiver to send a message and initiate chat;
sending a message to the receiver;
storing the message to the handheld device;
displaying the message to the chat history display; and
storing the message as chat history.

28. The method of claim 27 wherein the input method a keyboard, a touchpad, or a speech recognition system.
